(19) United States
(12) Patent Application Publication
(10) Pub. No.: US 2020/0390267 A1
(43) Pub. Date: Dec. 17, 2020

(54) BREWING SUBSTANCE CONTAINER FOR USE IN BREWING MACHINE

(71) Applicant: Life's a Venture, LLC, Charlotte, NC (US)

(72) Inventors: Baxter Cook, Charlotte, NC (US); Cheery Furr, Charlotte, NC (US)

(73) Assignee: Life's a Venture, LLC, Charlotte, NC (US)

(21) Appl. No.: 16/903,088

(22) Filed: Jun. 16, 2020

Related U.S. Application Data
(60) Provisional application No. 62/862,173, filed on Jun. 17, 2019.

(51) Int. Cl. A47J 31/06; A47J 31/08; A23F 5/14

(52) U.S. Cl. CPC A47J 31/0642; A23V 2002/00; A23F 5/14; A47J 31/08

(57) ABSTRACT

Disclosed is a container for a brewing substance, where the container comprises a housing having an interior; a brewing substance located in the interior of the housing; and a non-liquid substance comprising at least one cannabinoid, such as cannabidiol (CBD), cannabigerol (CBG), and/or cannabinol (CBN). In one embodiment, a filter contains the brewing substance in the housing and the non-liquid substance is located below the filter. Also disclosed are methods of assembling the container.

### CROSS-REFERENCE TO RELATED APPLICATION(S)

This application is a non-provisional of and claims priority to U.S. Provisional Patent Application No. 62/862,173, filed Jun. 17, 2019, of the same title; the contents of which are also incorporated by reference herein in its entirety.

### FIELD OF THE INVENTION

The invention relates to a brewing container for housing a substance in a pre-brewed state, where the brewing container further comprises at least one of: full spectrum, broad spectrum, or isolate of water soluble powder substance comprising at least one cannabinoid, such as, for example, cannabidiol (CBD), cannabigerol (CBG), and/or cannabinol (CBN), to be admixed and/or dissolved into a brewing liquid passing through the container during a brewing process.

### BACKGROUND OF THE INVENTION

Prior systems are known for including “CBD”, “Hemp Oil”, etc. into single-serve brewing containers, such as K-Cup® for use in instant brewing machines, such as a Keurig®. However, these prior art systems used the oil form of cannabinoids such as CBD, with has been found to be absorbed by the brewing container housing material, the filter in the housing, and/or the pre-brewed substance, e.g., coffee granules or tea leaves. This absorption in turn prohibits the cannabinoid from infusing into the brewing liquid, as it is brewed in the brewing container.

### SUMMARY OF THE INVENTION

To better infuse cannabinoid(s) into the brewing liquid, as it brews, it was determined to be advantageous to provide the cannabinoids in a powdered form to prevent the cannabinoids from infusing into the container, filter, and pre-brewed substance. The developed cannabinoid powder is mixed with a filler with the same molecular weight, so as to be of sufficient quantity for inclusion in the brewing container. This powdered form of cannabinoids may then be admixed and/or dissolved into the brewing liquid, as the liquid flows through the brewing container in the brewing process.

As an example, in one embodiment a brewing container is provided for a brewing substance, where the brewing container comprises a housing having an interior cavity. A brewing substance and a non-liquid substance comprising at least one cannabinoid are both located in the interior cavity of the housing.

In one embodiment, the brewing substance and the non-liquid substance are located in separate locations in the interior cavity of the housing. For example, in one embodiment, the container comprises a filter located in the interior cavity of the housing that contains the brewing substance in a position above the non-liquid cannabinoid containing substance, such that liquid flowing through the container during brewing, first passes through the brewing substance, through the filter, and then mixes with and/or dissolves the non-liquid substance so as to infuse the non-liquid substance into the brewing liquid as it exits the container.

In one embodiment, the non-liquid substance is in the form of a powder.

In one embodiment, the non-liquid substance comprises at least one cannabinoid and a filler material. As an example, in one embodiment, the non-liquid substance comprises: at least one cannabinoid isolate crystalline powder at 3.50% Weight and Maltodextrin at 96.50% Weight, for a Total Weight of 1 Gram/100%.

In one embodiment, the non-liquid substance comprises one of: a full spectrum of cannabinoids, a broad spectrum of cannabinoids, or an isolate of a cannabinoid.

In one embodiment, the non-liquid substance comprises at least one of cannabidiol (CBD), cannabigerol (CBG), and/or cannabinol (CBN).

Methods for assembling a brewing container for housing a brewing substance are also disclosed. In one embodiment, the method comprises: inserting a brewing substance into an interior of a housing of the brewing container and inserting a non-liquid substance comprising at least one cannabinoid into the interior of the housing.

In some embodiments of the method, a filter is located in the interior cavity of said housing and contains the brewing substance. And in some embodiments, the non-liquid substance is inserted so as to be located in the interior of said housing of the brewing container below said filter.

### DESCRIPTION OF THE DRAWINGS

FIG. 1 are test results according to one embodiment depicting the concentration of a cannabinoid(s) in a brewed liquid following a brewing process.

FIG. 2A is depiction of a brewing container for a brewing substance and its internal contents, according to one embodiment of the present invention.

FIG. 2B is a depiction of a multicomponent filter according to one embodiment of the present invention.

FIG. 2C is a depiction of a flow through filter according to one embodiment of the present invention.

FIG. 2D is a depiction of a multicomponent filter according to one embodiment of the present invention with the cannabinoid powder substance placed below the filter.

### DETAILED DISCUSSION

The system can achieve infusion in a single-serve brewing container of either a full spectrum, broad spectrum, or isolate cannabinoid substance in powder form. A cannabinoid substance in crystalline powder form is very potent and strongest available. It also typically easy to dissolve into the coffee, tea, hot chocolate, etc. before exiting the single-serve brewing container. The formulation can be placed in the beverage itself, on the top, middle or bottom of the brewing container. However, during studies, it was determined that maximum extraction can be achieved by placing the cannabinoid comprising powder on the bottom of the single-serve brewing container, whereas, in the other placement and locations there is more potential for loss during extraction. For example, in one embodiment, the cannabinoid powder substance is placed below the filter in the container, with the brewing substance located above in the filter. This configuration allows for maximizing the extraction of all cannabinoids in the non-liquid cannabinoid comprising substance. It also ensures the highest bioavailability for absorption into the bodies cannabinoid receptors.

As it will be understood, various formulations of the cannabinoid powder are envisioned. For example in some embodiments, the non-liquid substance powder comprises one of: a full spectrum of cannabinoids, a broad spectrum of cannabinoids, or an isolate of a cannabinoid. In one embodiment, the non-liquid substance comprises at least one of cannabidiol (CBD), cannabigerol (CBG), and/or cannabinol (CBN). In some embodiments, the non-liquid substance comprises at least one cannabinoid and a filler material having a same molecular weight, so as to be of sufficient quantity for inclusion in the brewing container.

For example, in one embodiment, the non-liquid substance comprises at least one cannabinoid and a filler material. As an example, in one embodiment, the non-liquid substance comprises: at least one cannabinoid isolate crystalline powder at 3.50% Weight and Maltodextrin at 96.50% Weight, for a Total Weight of 1 Gram/100.

The mixture, for example, was achieved by mixing 19.3 grams (96.5%) of Maltodextrin with 0.7 grams (3.5%) of CBD isolate powder together for approximately three (3) minutes. Following mixing, 1 gram of the mixture was added to the bottom of a brewing container. A filter was then inserted, along with a brewing substance located in the filter. A brewing liquid, such as hot water, was then flowed through the container.

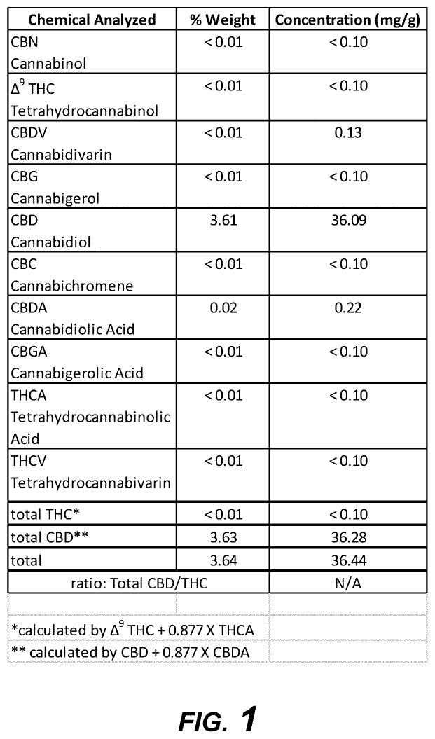

With reference to FIG. 1, results are provided for this mixture of a cannabinoid isolate crystalline powder with the Maltodextrin filler. In this example, a hot water soluble powder demonstrates full extraction Total Yields: 32.5-37.5 mg per single-serve brewing container. (See FIG. 1 for testing results illustrating the total cannabinoid profile).

As another example, a full spectrum cannabinoid substance was sifted and then 1 gram was added to a brewing container to provide an embodiment of the invention where the brewing container comprised 1 gram of the full spectrum cannabinoid in powder form below a filter containing the brewing substance, so that brewing liquid flowing through the container would admix with and/or dissolve the powder into the brewing liquid.

As is understood, any formulation of the cannabinoid substances can be used, depending on the desired properties of the brewing liquid following the brewing process. For example, the non-liquid substance could comprise one of or any number of cannabinoids, such as: Tetrahydrocannabinolic Acid (THCA), Tetrahydrocannabinol (THC), Cannabidiolic Acid (CBDA), Cannabidiol (CBD), Cannabinol (CBN), Cannabigerol (CBG), Cannabichromene (CBC), and Tetrahydrocannabivarin (THCV). The non-liquid substance could be a full spectrum substance meaning that it comprises substantially all the cannabinoids that are naturally occurring in the cannabis plant. Alternatively, the non-liquid substance could be a broad spectrum substance meaning that it comprises substantially all the cannabinoids that are naturally occurring in the cannabis plant but for the presence of THC. Further, in some embodiments, the non-liquid substance may be an isolate, meaning it is a cannabinoid in substantially pure form, such as for example an isolate of Cannabidiol (CBD), Cannabinol (CBN), or Cannabigerol (CBG).

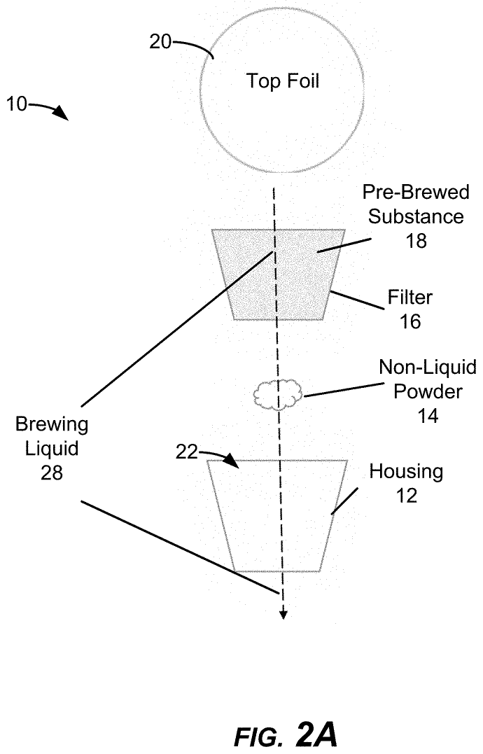

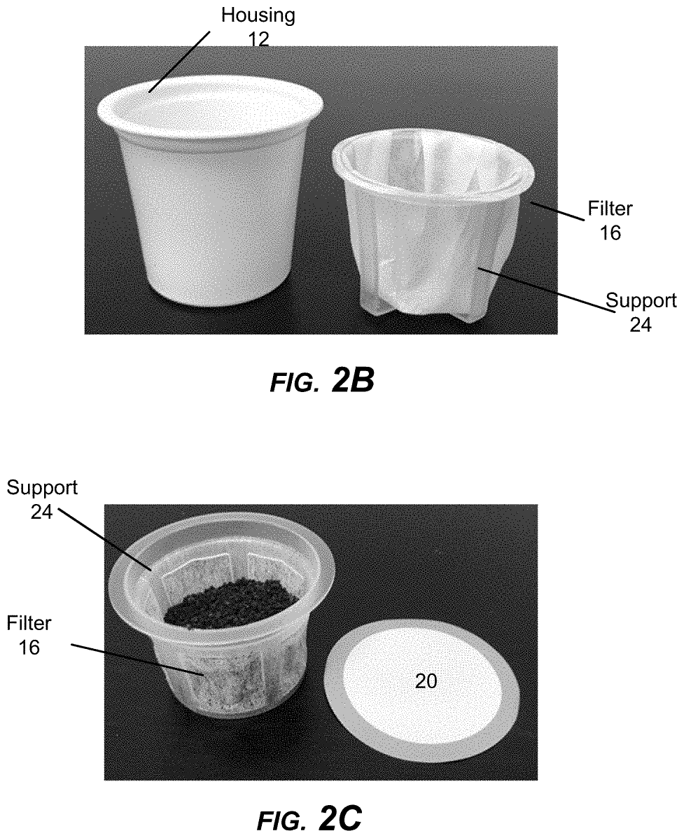

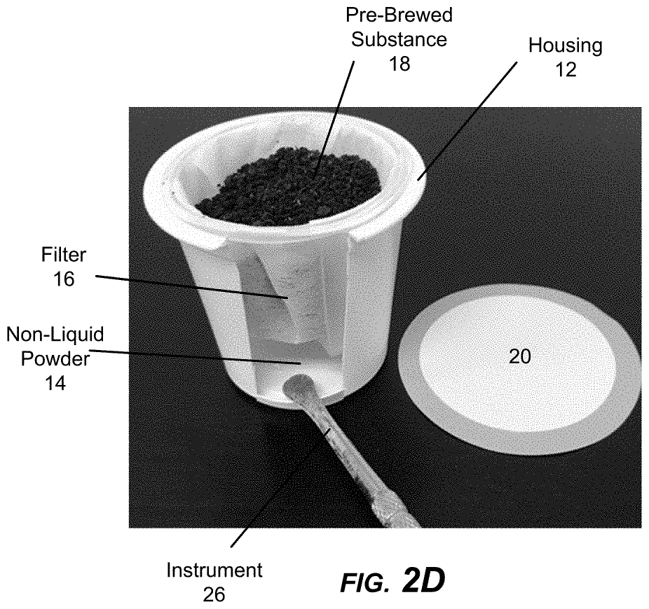

FIGS. 2A-2D describe the construction of a brewing container and use thereof according to one embodiment of the present invention. As shown in FIGS. 2A-2D, in one embodiment a five (5) stage/component single-serve brewing container 10 with a foil lid is assembled. The five (5) components are:
1. Brewing container 10 with an interior cavity 22 in its housing 12;
2. Non-liquid powder formula 14 dosed into the bottom of the brewing container housing 12, here approximately 1 g of formula 14 (FIG. 2D illustrates placement of the non-liquid substance formula 14 into the brewing container with an inserting instrument 26);
3. Filter 16 with support 24 inserted into the interior cavity of the brewing container housing 12 above the formula 14 (FIG. 2B depicts of a multicomponent filter with a filter 16 and separate support 24, while FIG. 2C depicts of a flow through filter where the filter 16 and support 24 are integrated into a common structure;
4. Brewing substance 18 located in the filter 16, such as coffee, tea, cocoa, or other brewable substance; and
5. Foil lid 20 connected with an upper rim of the brewing container, so as to seal the brewing substance, filter, and formula in the brewing container housing 12.

FIG. 2A demonstrates the brewing/extraction process. The brewing container is inserted into a brewer, not shown. The brewer punctures both the top foil lid 20 and the bottom of the brewing container 12. Brewing liquid 28, such as hot water, is then introduced into the brewing container. Twelve (12) oz of brewing liquid is typical for full extraction of the cannabinoid(s) where 1 gram of cannabinoid is used. The pre-brewing substance is brewed, such as coffee or tea, and the brewing liquid travels through the pre-brewing substance, and through the filter. Once evacuating the filter, the brewing liquid and non-liquid cannabinoid formula 14 mix/dissolves in the bottom of the housing of the brewing container 12 container, and then exits the brewing container. In this design, little to no residual cannabinoids substances being left behind.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A container for a brewing substance comprising:
a housing having an interior cavity;
a brewing substance located in the interior cavity of said housing; and
a non-liquid substance comprising at least one cannabinoid located in the interior cavity of said housing.

2. A container according to claim 1, wherein said brewing substance and said non-liquid substance are located in separate locations in the interior of said housing.

3. A container according to claim 1 further comprising a filter located in the interior cavity of said housing and containing said brewing substance.

4. A container according to claim 3, wherein said non-liquid substance is located in the interior cavity of said housing below said filter.

5. A container according to claim 1, wherein said non-liquid substance is in the form of a powder.

6. A container according to claim 1, wherein said non-liquid substance comprises at least one cannabinoid and a filler material.

7. A container according to claim 6, wherein said non-liquid substance comprises:
at least one cannabinoid isolate crystalline powder at 3.50% Weight; and
Maltodextrin at 96.50% Weight,
for a Total Weight of 1 Gram/100%.

8. A container according to claim 1, wherein said non-liquid substance comprises one of: a full spectrum of cannabinoids, a broad spectrum of cannabinoids, or an isolate of a cannabinoid.

9. A container according to claim 1, wherein said non-liquid substance comprises at least one of cannabidiol (CBD), cannabigerol (CBG), and/or cannabinol (CBN).

10. A method of assembling a container for housing a brewing substance, said method comprising:
inserting a brewing substance into an interior cavity of a housing; and
inserting a non-liquid substance comprising at least one cannabinoid into the interior cavity of the housing.

11. A method according to claim 10 further comprising locating said brewing substance and said non-liquid substance in separate locations in the interior of said housing.

12. A method according to claim 10 further comprising:
inserting a filter located in the interior cavity of said housing and containing said brewing substance.

13. A method according to claim 12, wherein said non-liquid substance is inserted so as to be located in the interior cavity of said housing below said filter.

14. A method according to claim 10, wherein said non-liquid substance is in the form of a powder.

15. A method according to claim 10, wherein said non-liquid substance comprises at least one cannabinoid and a filler material.

16. A method according to claim 15, wherein said non-liquid substance comprises:
at least one cannabinoid isolate crystalline powder at 3.50% Weight; and
Maltodextrin at 96.50% Weight,
for a Total Weight of 1 Gram/100%.

17. A method according to claim 10, wherein said non-liquid substance comprises one of: a full spectrum of cannabinoids, a broad spectrum of cannabinoids, or an isolate of a cannabinoid.

18. A method according to claim 10, wherein said non-liquid substance comprises at least one of cannabidiol (CBD), cannabigerol (CBG), and/or cannabinol (CBN).

19. A container for a brewing substance comprising:
a housing having an interior cavity;
a brewing substance located in the interior cavity of said housing;
a filter located in the interior cavity of said housing and containing said brewing substance; and
a non-liquid substance located below said filter comprising at least one cannabinoid.
